(19) United States
(12) Patent Application Publication
(10) Pub. No.: US 2005/0079403 A1
(43) Pub. Date: Apr. 14, 2005

(54) Fuel cell gas diffusion layer

(75) Inventors: Stephen M. Lipka, Nicholasville, KY (US); Shawn Zhao, Westboro, MA (US)

Correspondence Address: FISH & RICHARDSON PC, 225 FRANKLIN ST, BOSTON, MA, 02110, US

(73) Assignee: Hollingsworth & Vose Company, East Walpole, MA (US)

(21) Appl. No.: 10/931,955

(22) Filed: Sep. 1, 2004

Related U.S. Application Data
(60) Provisional application No. 60/501,679, filed on Sep. 10, 2003.

(51) Int. Cl. H01M 4/96; H01M 4/88; D01F 9/12

(52) U.S. Cl. 429/44; 502/101; 423/447.1; 423/447.2

(57) ABSTRACT

Fuel cell gas diffusion layers are disclosed.

### CROSS-REFERENCE TO RELATED APPLICATION

This application claims priority under 35 U.S.C. §119(e) to U.S. Provisional Patent Application Ser. No. 60/501,679, filed Sep. 10, 2003, and entitled “Fuel Cell Gas Diffusion Layer”, which is hereby incorporated by reference.

### TECHNICAL FIELD

The invention relates to fuel cell gas diffusion layers.

### BACKGROUND

Fuel cells can be used to convert chemical energy to electrical energy by promoting a chemical reaction between, for example, hydrogen and oxygen.

FIG. 1 shows an embodiment of a fuel cell 100. Fuel cell 100 includes a solid electrolyte 110, a cathode catalyst 120, an anode catalyst 130, a cathode gas diffusion layer 140, an anode gas diffusion layer 150, a cathode flow field plate 160 having channels 162, and an anode flow field plate 170 having channels 172.

Solid electrolyte 110 can be formed of a solid polymer, such as a solid polymer ion exchange resin (e.g., a solid polymer proton exchange membrane). Examples of proton exchange membrane materials include partially sulfonated, fluorinated polyethylenes, which are commercially available as the NAFION® family of membranes (E.I. DuPont deNemours Company, Wilmington, Del.).

Cathode and anode catalysts 120 and 130 can be formed, for example, of platinum, a platinum alloy, or platinum dispersed on carbon black.

Cathode and anode flow field plates 160 and 170 can be formed of a solid, electrically conductive material, such as graphite.

Typically, fuel cell 100 operates as follows.

Hydrogen enters anode flow field plate 170 at an inlet region of anode flow field plate 170 and flows through channels 172 toward an outlet region of anode flow field plate 170. At the same time, oxygen (e.g., air containing oxygen) enters cathode flow field plate 160 at an inlet region of cathode flow field plate 160 and flows through channels 162 toward an outlet region of cathode flow field plate 160.

As the hydrogen flows through channels 172, the hydrogen passes through anode gas diffusion layer 150 and interacts with anode catalyst 130, and, as oxygen flows through channels 162, the oxygen passes through cathode gas diffusion layer 140 and interacts with cathode catalyst 120. Anode catalyst 130 interacts with the hydrogen to catalyze the conversion of the hydrogen into electrons and protons, and cathode catalyst 120 interacts with the oxygen, electrons and protons to form water. The water flows through gas diffusion layer 150 to channels 162, and then along channels 162 toward the outlet region of cathode flow field plate 160.

Solid electrolyte 110 provides a barrier to the flow of the electrons and gases from one side of electrolyte 110 to the other side of the electrolyte 110. But, electrolyte 110 allows the protons to flow from the anode side of membrane 110 to the cathode side of membrane 110. As a result, the protons can flow from the anode side of membrane 110 to the cathode side of membrane 110 without exiting fuel cell 100, whereas the electrons flow from the anode side of membrane 110 to the cathode side of membrane 110 via an electrical circuit that is external to fuel cell 100. The external electrical circuit is typically in electrical communication with anode flow field plate 170 and cathode flow field plate 160.

In general, the electrons flowing through the external electrical circuit are used as an energy source for a load within the external electrical circuit.

### SUMMARY

The invention relates to fuel cell gas diffusion layers.

In one aspect, the invention features a fuel cell gas diffusion layer that includes a plurality of substantially homogeneous carbon-containing fibers. At least some of the fibers are fused, and the fuel cell gas diffusion layer has a flexural strength of at least about 300 psi (e.g., at least about 450 psi, at least about 600 psi).

In another aspect, the invention features a membrane electrode assembly that includes two catalyst layers, a solid electrolyte and two gas diffusion layers. One of the catalyst layers is between the solid electrolyte and one of the gas diffusion layers, and the other catalyst layer is between the solid electrolyte and the other gas diffusion layer. At least one (e.g., both) of the gas diffusion layers has a flexural strength of at least about 300 psi and includes a plurality of substantially homogeneous carbon-containing fibers with at least some of the fibers being fused.

In a further aspect, the invention features a fuel cell that includes two flow field plates and a membrane electrode assembly between the flow field plates. The membrane electrode assembly includes two catalyst layers, a solid electrolyte and two gas diffusion layers. One of the catalyst layers is between the solid electrolyte and one of the gas diffusion layers, and the other catalyst layer is between the solid electrolyte the other gas diffusion layer. At least one (e.g., both) of the gas diffusion layers has a flexural strength of at least about 300 psi and includes a plurality of substantially homogeneous carbon-containing fibers with at least some of the fibers being fused.

In one aspect, the invention features a method of forming a fuel cell gas diffusion layer. The method includes treating a first web of fibers at a temperature of at most about 250° C. to form a second web of fibers, and treating the second web of fibers at a temperature of at least about 400° C. to form the fuel cell gas diffusion layer.

In another aspect, the invention features a method of forming a fuel cell gas diffusion layer. The method includes treating a first web of fibers at a temperature of at most about 250° C. to form a second web of fibers, and treating the second web of fibers at a temperature of at most about 1100° C. to form the fuel cell gas diffusion layer.

Embodiments can include one or more of the following features.

The fuel cell gas diffusion layer can have a strength of at least about four pounds per inch (e.g., at least about six pounds per inch, at least about 10 pounds per inch).

The fuel cell gas diffusion layer can have an in-plane resistivity of at most about 50 mΩ-cm (e.g., at most about 10 mΩ-cm, at most about five mΩ-cm).

The fuel cell gas diffusion layer can have a through-plane resistivity of at most about 200 mΩ-cm (e.g., at most about 50 mΩ- cm, at most about 10 mΩ- cm).

The fuel cell gas diffusion layer can have a porosity of at least about 30% (e.g., at least about 60%, at least about 80%).

The fuel cell gas diffusion layer can be in the form of a web (e.g., a substantially binder-free web).

The method can include treating the first web at a temperature of at most about 240° C. (e.g., at most about 230° C.).

The method can include treating the second web at a temperature of at least about 500° C. (e.g., at least about 600° C.).

The method can include treating the second web at a temperature of at most about 1100° C. (e.g., at most about 1050° C., at most about 1000° C.).

The method can include treating the first web in a substantially inert gas environment.

The method can include treating the second web in a substantially inert gas environment.

The first web can be treated at a pressure of at least about one atmosphere.

The second web can be treated at a pressure of at least about one atmosphere.

The method can include flowing a gas at a rate of at least about 0.5 L/min. while treating the first web.

The method can include flowing a gas at a rate of at least about 0.5 L/min. while treating the first web.

Certain embodiments can provide one or more of the following advantages.

In certain embodiments, the gas diffusion layer can exhibit good flexural strength. This can be desirable because it can allow the gas diffusion layer to be used in a fuel cell with a reduced likelihood of cracking or tearing. This can also be advantageous because it can allow the use of an automated process when making the material from which the gas diffusion layer is formed, which can allow the material to be made in relatively large quantities (e.g., relatively long sheets).

In certain embodiments, the gas diffusion layer can exhibit good strength, which can, for example, allow the gas diffusion layer to contribute to the mechanical integrity of the fuel cell.

In some embodiments, the gas diffusion layer can have the appropriate amount of porosity so that, when the gas diffusion layer is present in a fuel cell, a reactant gas (e.g., hydrogen, oxygen) can flow through the gas diffusion layer to reach the corresponding catalyst layer and a product (e.g., liquid water, water vapor) can flow through the gas diffusion layer to reach the channels in the cathode flow field plate.

In certain embodiments, the gas diffusion layer can have a relatively low in-plane resistivity and/or a relatively low through-plane resistivity. This can be advantageous, for example, because it can reduce the intrinsic resistivity of a fuel cell containing the gas diffusion layer, thereby increasing the efficiency of the fuel cell.

In some embodiments, the material from which the gas diffusion layer is formed can be relatively pure. This can be desirable because, for example, it can enhance the chemical inertness of the gas diffusion layer. In certain embodiments, the gas diffusion layer can be relatively chemically inert to the reactants and products typically present during use of the fuel cell. This can be advantageous, for example, because it can increase the useful lifetime of a fuel cell containing the gas diffusion layer relative to an otherwise substantially similar fuel cell that contains a gas diffusion layer that is not as chemically inert.

In some embodiments, the gas diffusion layer can simultaneously exhibit desirable levels of flexural strength, mechanical strength, in-plane resistivity, through-plane resistivity, porosity and chemical inertness.

In certain embodiments, the gas diffusion layer can be in the form of a substantially binder-free web. This can be advantageous for one or more of the following reasons. Often, the binder used in a web has a relatively high resistivity, so the binder may be processed (e.g., at relatively high temperature) to render the web sufficiently electrically conductive for use in a gas diffusion layer. However, such processing can result in the web material having insufficient flexural strength to be used as gas diffusion layer and/or having insufficient flexural strength to be processed in an automated process to make the web in relatively large quantities (e.g., relatively long sheets). A substantially binder-free web can provide a material that has appropriate flexural strength for use as a gas diffusion layer, that can be prepared by a relatively low temperature process, and/or that can be more readily prepared in an automated process to make the web in relatively large quantities (e.g., relatively long sheets).

In some embodiments, the method can be relatively simple (e.g., involve relatively few process steps) and/or inexpensive (e.g., involve relatively low process temperatures). As an example, in certain embodiments, the gas diffusion layer can be prepared without processing a binder (e.g., without processing a binder contained in the web to increase the electrical conductivity and/or mechanical strength of the material). As another example, in some embodiments, the gas diffusion layer can be prepared without using a temperature above about 1500° C. (e.g., without using a temperature above about 1300° C., without using a temperature above about 1150° C.).

Features, objects and advantages of the invention are in the description, drawings and claims.

### DESCRIPTION OF DRAWINGS

FIG. 1 is a cross-sectional view of an embodiment of a fuel cell;

FIG. 2 is an illustration of an embodiment of a gas diffusion layer;

FIGS. 3-29 are scanning electron micrographs.

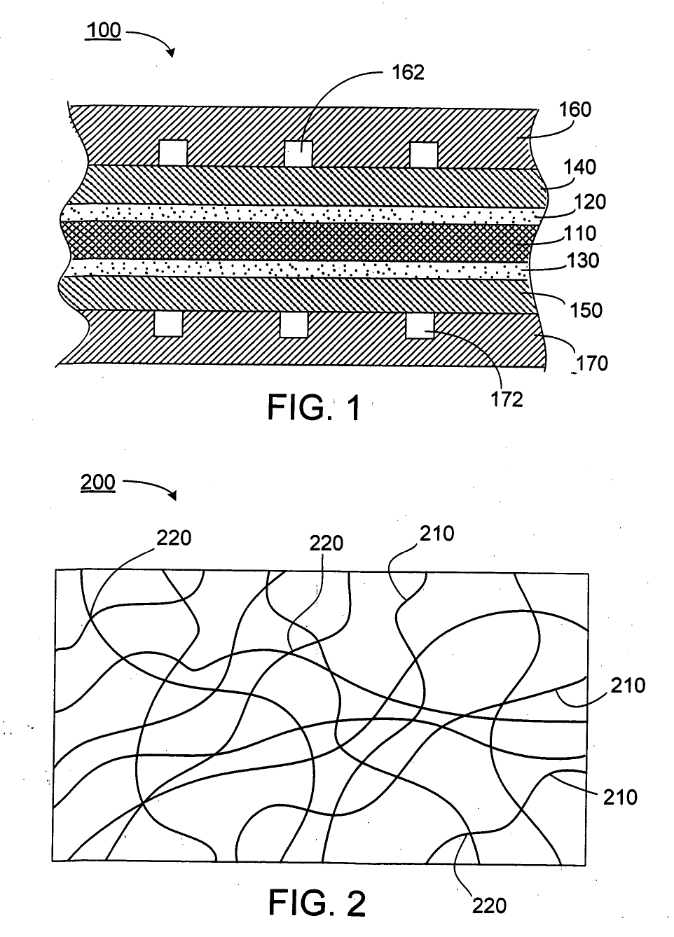

### DETAILED DESCRIPTION

FIG. 2 is an illustration of a gas diffusion layer 200 formed of homogeneous fibers 210 that are fused at locations 220. As used herein, a homogeneous fiber refers to a fiber that has a substantially uniform chemical composition along a cross-section of the fiber taken in the direction normal to the length of the fiber.

Gas diffusion layer 200 is in the form of a substantially binder-free web. As referred to herein, substantially binder-free means containing at most about one weight percent (e.g., at most about 0.5 weight percent, at most about 0.1 weight percent) binder. As used herein, a web refers to a plurality of fibers that form a three dimensional structure with one dimension (e.g., thickness) being much smaller (e.g., at least about 10 times smaller, at least about 100 times smaller) than either of the other two dimensions (e.g., length, width). Examples of types of webs include hydroentagled webs, wet laid webs and dry laid webs.

In some embodiments, gas diffusion layer 200 has a flexural strength of at least about 300 psi (e.g., at least about 450 psi, at least about 600 psi). As referred to herein, the flexural strength of a gas diffusion layer is determined based on the compression modulus and caliper of the gas diffusion layer.

In certain embodiments, gas diffusion layer 200 has a strength of at least about four pounds per inch (e.g., at least about six pounds per inch, at least about 10 pounds per inch). As referred to herein, the strength of a gas diffusion layer is measured according to TAPPI T-494.

In certain embodiments, gas diffusion layer 200 has a through-plane resistivity of at most about 200 mΩ-cm (e.g., at most about 50 mΩ-cm, at most about 10 mΩ-cm, at most about five mΩ-cm). The through-plane resistivity of a gas diffusion layer, as referred to herein, is measured according to ASTM B 193-95.

In some embodiments, gas diffusion layer 200 has an in-plane resistivity of at most about 50 mΩ-cm (e.g., at most about 10 mΩ-cm, at most about five mΩ-cm). As referred to herein, the in-plane resistivity of a gas diffusion layer is measured according to ASTM B 193-95.

In certain embodiments, gas diffusion layer 200 has a porosity of at least about 30% (e.g., at least about 60%, at least about 80%). The porosity of a gas diffusion layer, as referred to herein, is measured based on the density and caliper of the gas diffusion layer.

In some embodiments, fibers 210 are formed of a relatively carbonaceous pure material. For example, in some embodiments, fibers 210 can be formed of at least about 99 weight percent carbon (e.g., at least 99.5 weight percent carbon, at least 99.9 weight percent carbon).

In some embodiments, gas diffusion layer 200 is prepared as follows.

Fibers of a starting material (e.g., a web of polyacrylonitrile fibers, polyethylene fibers, polypropylene fibers, Kevlar fibers) are heated in a gas environment (e.g., air, oxygen, nitrogen) for a period of time (e.g., at most about four hours, from about 30 minutes to about two hours) so that the fibers are partially, but generally not fully, oxidized. The temperature to which the starting material is heated is generally at least about 150° C. (e.g., at least about 160° C., at least about 180° C.) and at most about 250° C. (e.g., at most about 240° C., at most about 230° C., at most about 220° C., at most about 210° C., at most about 200° C., at most about 190° C., from about 180° C. to about 190° C.). In some embodiments, the temperature is from about 180° C. to about 230° C. (e.g., from about 190° C. to about 230° C.). The flow rate of the gas is typically at least about 0.5 L/min. (e.g., about 1 L/min., about 2 L/min.). Optionally, the gas environment can be stagnant. In general, the pressure of the gas is at least about atmospheric pressure (e.g., from about one atmosphere to about three atmospheres, about one atmosphere).

The resulting material is subsequently heated at an increased temperature in a relatively inert gas environment for a period of time to form the gas diffusion layer. The increased temperature is generally at least about 400° C. (e.g., at least about 500° C., at least about 600° C., at least about 700° C.) and at most about 1100° C. (e.g., at most about 1000° C., at most about 900° C.). In some embodiments, the temperature is from about 600° C. to about 1100° C. The gas environment generally contains one or more inert gases (e.g., helium, neon, krypton, argon and/or nitrogen). The gas environment can be stagnant or can be a flowing gas environment. If a flowing gas environment is used, the gas flow rate is typically 0.5 L/min. (e.g., about 1 L/min., about 2 L/min.). In general, the pressure of the gas is at least about atmospheric pressure (e.g., from about one atmosphere to about three atmospheres, about one atmosphere).

The gas flow rate and period of time can be as described above.

Without wishing to be bound by theory, it is believed that using a relatively low temperature process can result in a web of fused fibers that exhibits appropriate flexural strength for use as a fuel cell gas diffusion layer while still exhibiting one or more other desirable properties for a fuel cell gas diffusion layer (e.g., strength, in-plane resistivity, through-plane resistivity, porosity, chemical intertness). In particular, it is believed that the flexural strength of the web of fused fibers is generally inversely proportional to the degree to which the fibers are fused, and that using a relatively low temperature process can result in a web with a lesser degree of fiber fusion and a higher flexural strength than might be obtained using a higher temperature process. It is further believed that this can provide a web of fused fibers that, while being more flexible than might be obtained using a higher temperature process, still exhibits other desirable properties for a gas diffusion layer (e.g., strength, in-plane resistivity, through-plane resistivity, porosity, chemical intertness).

The following examples are illustrative only and not intended as limiting. SEM were taken using a Hitachi S-2700 scanning electron microscope, operated at 20 KV in SE imaging mode.

### EXAMPLE 1

A Courtaulds nonwoven PAN fiber substrate (160 g/m²) weighing 3.285 g was sandwiched between 2 quartz plates and placed into a 4 inch tube furnace. Nitrogen (1 L/min.) was allowed to flow over the sample for a period of 15 min. at room temperature to displace air in the tube. Afterwards, the furnace was ramped at 10° C./min. until it reached 200° C. while nitrogen continued to flow. The sample was allowed to soak at 200° C. for 2 h while nitrogen continued to flow. One end cap of the furnace (at the nitrogen inlet) was then removed and air was allowed to diffuse into the tube for 18 minutes while the sample was held at 200° C. (period in which the entire sample turned uniformly black). A crack was observed on the substrate nitrogen inlet side about 15 minutes after the sample was exposed to air. Next, the end cap was replaced and nitrogen flow was resumed at 1 L/min. The furnace was then ramped to 700° C. at 10° C./min while nitrogen flow continued. The sample was soaked at these conditions for 1 hour after which the furnace was turned off and allowed to cool for about 2.5 h. During the cool down period, the nitrogen flow rate remained at 1 L/min. The final weight of the sample was 2.264 g. The sample remained somewhat flexible indicating lack of fused or bonded fiber.

### EXAMPLE 2

A Courtaulds nonwoven PAN fiber substrate (80 g/m²) weighing 2.147 g was sandwiched between 2 quartz plates and placed into a 4 inch tube furnace and ramped to 200° C. at 5° C./min. under flowing air (2 L/min.) The sample was soaked at 200 C for a period of 1 h while nitrogen continued to flow (2 L/min.). The sample was then ramped 5° C./min to 700° C. under flowing nitrogen (2 L/min.), and soaked at this temperature for 1 h while nitrogen (2 L/min. ) was allowed to flow. The sample was allowed to cool to room temperature overnight under flowing nitrogen (2 L/min.). The resultant sample was intact. The final weigh was 1.5 g.

### EXAMPLE 3

A Courtaulds nonwoven PAN fiber substrate (80 g/m²) weighing 2.58 g was sandwiched between 2 quartz plates and placed into a 4 inch tube furnace and ramped to 200° C. at 5° C./min. under flowing air (2 L/min.). The sample was soaked at 200° C. for a period of 30 min under air. The sample was then ramped 5° C./min to 700° C. under flowing nitrogen (2 L/min.), and soaked at this temperature for 1 h while nitrogen (2 L/min.) was allowed to flow. The sample was allowed to cool for 2 h under flowing nitrogen (2 L/min.). The resultant sample was intact. The final weight was 1.7 g.

### EXAMPLE 4

A Courtaulds nonwoven PAN fiber substrate (80 g/m²) weighing 2.3 g was sandwiched between 2 quartz plates and placed into a 4 inch tube furnace and ramped to 200° C. at 5° C./min. under flowing air (2 L/min.). The sample was soaked at 200° C. for a period of 15 min while air continued to flow. The sample was then ramped 5° C./min to 700° C. under flowing nitrogen (2 L/min.), and soaked at this temperature for 1 h while nitrogen (2 L/min.) was allowed to flow. The sample was allowed to cool for 2 h under flowing nitrogen (2 L/min.). The resultant sample was intact. The final weight was 1.59 g.

### EXAMPLE 5

A Courtaulds nonwoven PAN fiber substrate (80 g/m²) weighing 2.367 g was sandwiched between 2 quartz plates and placed into a 4 inch tube furnace and ramped to 230° C. at 5° C./min. under flowing nitrogen (1 L/min.). After 1 h under nitrogen and 230 ° C., the sample was entirely black. The sample was then switched to air (1 L/min) for 15 min. at 230° C. followed again by nitrogen (1 L/min) and continued to ramp at 5° C./min to 700° C. under flowing nitrogen (1 L/min.). The sample was soaked at 700° C. for 1 h. The sample was allowed to cool for 2 h under flowing nitrogen (2 L/min.). For the most part, the resultant sample was intact and somewhat flexible. The final weigh was 1.5804 g.

### EXAMPLE 6

A Courtaulds nonwoven PAN fiber substrate (80 g/m²) weighing 2.1404 g was sandwiched between 2 quartz plates and placed into a 4 inch tube furnace and initially purged at 4 L/min. for 15 min. to displace the air in the tube. The sample was then ramped to 230° C. at 10° C./min. under flowing nitrogen (1 L/min.). After 30 min. under nitrogen and 230 C, the sample was copper colored at the inlet side and black on the exhaust side. The sample was then switched to air (1 L/min) for 15 min. at 230 C followed again by nitrogen (1 L/min) and continued to ramp at 10 C/min to 700 C. The sample was soaked at 700 C for 1 h under flowing nitrogen (1 L/min). The sample was allowed to cool for 2 h under flowing nitrogen (2 L/min.). The resultant sample was intact and somewhat flexible with no cracking. The final weigh was 1.5687 g. SEM revealed no bonding throughout the entire sample as samples were taken form the gas inlet, gas exhaust and middle of the sample.

### EXAMPLE 7

A Courtaulds nonwoven PAN fiber substrate (80 g/m²) weighing 1.9806 g was sandwiched between 2 quartz plates and placed into a 4 inch tube furnace and initially purged at 4 L/min for 15 min. to displace the air in the tube. The sample was then ramped to 190° C. at 10°/min. flowing nitrogen (2 L/min.). After 60 min. under nitrogen at 190° C. the sample was mostly copper colored. The sample was then checked at 90 min., this time the sample was still mostly copper colored. After soaking for 90 min under nitrogen at 190° C., the furnace was the ramped to 700° C. under nitrogen and allowed to soak for 60 min. The sample was then allowed to cool under nitrogen flow. When taken out sample was very rigid and in pieces. The final weight of the sample was 1.019 g. SEM revealed heavy bonding throughout the sample, and flat places a lot the fiber from the quartz.

### EXAMPLE 8

A Courtaulds nonwoven PAN fiber substrate (80 g/m²) weighing 2.363 g was placed upon 1 quartz plate and placed into a 4 inch tube furnace and initially purged at 4 L/min for 15 min. to displace the air in the tube. The sample was then ramped to 190° C. at 10°/min. flowing nitrogen (2 L/min.). After soaking for 90 min under nitrogen at 190° C., the furnace was the ramped to 700° C. under nitrogen and allowed to soak for 60 min. The sample was then allowed to cool under nitrogen flow. The resultant sample appeared to be intact and flexible with little to no bonding. The final weight of the sample was 1.1 g. SEM showed little bonding in the sample.

### EXAMPLE 9

A Courtaulds nonwoven PAN fiber substrate (80 g/m²) weighing 1.764 g sample was set upon a quartz plate, placed into a 4 inch tube furnace and initially purged at 4 L/min for 15 min. to displace the air in the tube. The sample was then ramped to 190° C. at 10°/min. flowing nitrogen (1 L/min.). After 30 min resultant sample was copper in color. After 60 min. under nitrogen at 190° C. the sample was mostly dark copper colored. The sample the checked at 90 min., this time the sample was still mostly dark copper colored. After soaking for 90 min under nitrogen at 190° C., the furnace was the ramped to 700° C. under nitrogen and allowed to soak for 60 min. The sample was then allowed to cool under nitrogen flow. The resultant sample was flexible with no cracking. The final weight of the sample was 0.815 g. SEM revealed little to no bonding in the sample.

### Sample 10

A Courtaulds nonwoven PAN fiber substrate (80 g/m²) weighing 1.671 g. The sample was placed upon a quartz plate, placed into a 4 inch tube furnace, and purged with nitrogen (4 L/min.) for 15 min. The sample was then ramped to 700° C. at 10° C./min. then held at 700 for 60 min. under nitrogen (1 L/min.) The sample was then allowed to cool, the resultant sample was balled up and very brittle with no flexibility. The PAN had no time for stabilization and therefore melted in the furnace. The final weight of the sample was 0.9661 g. SEM show heavy bonding of the fibers along with places where the fiber had completely melted.

### EXAMPLE 11

A Courtaulds nonwoven PAN fiber substrate (80 g/m²) weighing 2.3403 g was set upon a quartz plate and placed into a 4 inch tube furnace and initially purged at 4 L/min for 15 min. to displace the air in the tube. The sample was then ramped to 190° C. at 10 °/min. flowing nitrogen (1 L/min.). After 30 min resultant sample was mid dark copper in color. After soaking for 30 min under nitrogen at 190° C., the furnace was the ramped to 700° C. under nitrogen and allowed to soak for 60 min. The sample was then allowed to cool under nitrogen flow. The resultant sample was flexible with no cracking. The final weight of the sample was 1.074 g. SEM revealed little to no bonding in the sample.

### EXAMPLE 12

A Courtaulds nonwoven PAN fiber substrate (80 g/m²) weighing 1.9560 g was placed upon a quartz plate and set into a 4 inch tube furnace. The furnace was then ramped to 180° C. under air at 10° C./min. Once 180° C. was reached the sample was allowed to set for 15 min under air. Sample appeared to be mostly black, inlet side was almost black but not black. The oven then was ramped to 700° C. under nitrogen (2 L/min.), once at 700° C. the sample set for 98 min. The sample was then allowed to cool. The sample was intact with little to no bonding throughout. The final weight of the sample was 1.2 g.

### EXAMPLE 13

A Courtaulds nonwoven PAN fiber substrate (80 g/m²) weighing 1.9095 was placed between two quartz plates and set into a 4 inch tube furnace. The furnace was then ramped to 185° C. at 10°/min. under 0 L/min flow. Once 185° C. was reached the sample was allowed to set for 70 min. under air and the sample appeared all black. After a 70 min. soaking period the furnace was then ramped to 700° C. and held there for 60 min. The sample was then allowed to cool for two hours. There was no flow of air or of nitrogen during the run. The sample came out intact and no bonding. The final weight of the sample was 1.338.

### EXAMPLE 14

A Courtaulds nonwoven PAN fiber substrate (80 g/m²) weighing 1.28 g was placed between to quartz plated and set into a 4 inch tube furnace. The furnace was then ramped to 200° C. at 10° C./min. under 1 L/min. flow of nitrogen. Once the furnace had reached 200° C. it was held there for 90 min. At the end of the 90 min period the furnace was then shut off and the sample allowed to cool. The sample was then taken out, to see by means of the SEM if there is any bonding is the sample. The sample was an Au color with the SEM showing no bonding. The final weigh of the sample was 1.20 g. The sample was then cut into 6 different pieces to run at different temperatures to find the temperature at which bonding occurs. The first piece weighing 0.2036 g was placed between two quartz plates and placed into a 4 inch tube furnace. The sample was then purged with nitrogen for 15 min, with 4 L/min. of nitrogen. The furnace was then ramped at 25° C./min. with 1 L/min of nitrogen till furnace reached 200° C., once 200° C. was reached the furnace was then ramped at 10° C./min. to 300° C. The sample was then allowed to soak for 30 min. before being shut off and cooled. The sample was black and not intact however the SEM showed no bonding in the sample. The final weigh of the sample was 1599 g. The second piece weighing 0.2230 was placed between two quartz plates and placed into a 4 inch tube furnace. The sample was then purged with nitrogen for 15 min, with 4 L/min. of nitrogen. The furnace was then ramped at 25° C./min. with 1 L/min of nitrogen till furnace reached 200° C., once 200° C. was reached the furnace was then ramped at 10° C./min. to 400° C. The sample was then allowed to soak for 30 min. before being shut off and cooled. The sample was black and not intact, SEM showed bonding on the sample. The final weigh of the sample was 0.1719 g. The third piece weighing 0.2353 g was placed between two quartz plates and placed into a 4 inch tube furnace. The sample was then purged with nitrogen for 15 min, with 4 L/min. of nitrogen. The furnace was then ramped at 25° C./min. with 1 L/min of nitrogen till furnace reached 200° C., once 200° C. was reached the furnace was then ramped at 10° C./min. to 350° C. The sample was then allowed to soak for 30 min. before being shut off and cooled. The sample was black and not intact, SEM showed bonding on the sample. The final weigh of the sample was 0.1314 g. The forth piece weighing 0.2978 g was placed between two quartz plates and placed into a 4 inch tube furnace. The sample was then purged with nitrogen for 15 min, with 4 L/min. of nitrogen. The furnace was then ramped at 25° C./min. with 1 L/min of nitrogen till furnace reached 200° C., once 200° C. was reached the furnace was then ramped at 10° C./min. to 325° C. The sample was then allowed to soak for 30 min. before being shut off and cooled. The sample was black and not intact, SEM showed no bonding on the sample. The final weigh of the sample was 0.2289 g. The fifth piece weighing 0.1316 g was placed between two quartz plates and placed into a 4 inch tube furnace. The sample was then purged with nitrogen for 15 min, with 4 L/min. of nitrogen. The furnace was then ramped at 25° C./min. with 1 L/min of nitrogen till furnace reached 200° C., once 200° C. was reached the furnace was then ramped at 10° C./min. to 700° C. The sample was then allowed to soak for 60 min. before being shut off and cooled. This run was used to determine at what temperature or range of temperatures bonding occurs in the pan sample. The sample was run in the same way that the sample before was done, stabilizing the PAN fiber before carbonizing it. This was done to minimize the variables by have all the pieces stabilized at the same time, in an atmosphere that has proven before to show bonding results. The sample was then taken out and again no bonding was seen. The fiber was then cut up to be used in several different runs. The ramp rate for each piece was 25° C./min., this was done to minimize stabilization time. After which the rate was then changed back to 10° C./min., this was done to replicate the experiment from before as much as possible. After all the runs it was noticed that the sample bonds between 325° C. and 350° C. Also this was noticed by the weight loss percentage. The most mass that was lost was around 350° C. It is concluded that most of the bonding that occurs in the PAN sample occurred in that range of temperatures.

### EXAMPLE 15

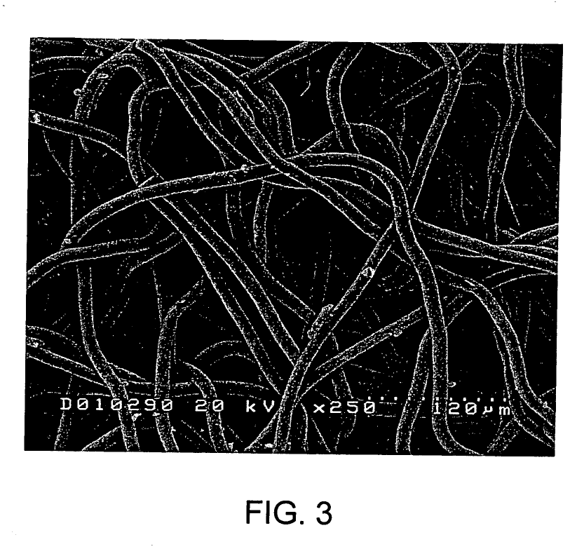

A Courtaulds nonwoven PAN fiber substrate (80 g/m²), weighing 0.2503 g, was placed between two quartz plates using 0.5 mm thick metal shims perpendicular to the sample(as shown if figure below). The configuration was placed into a 4 inch tube furnace. The furnace was ramped to 190° C. at 10° C./min. under a 2 L/min nitrogen flow. Once the furnace reached 190° C. it was held at this temperature for 90 min. under the same flow of nitrogen. At the end of the 90 min period the furnace was then ramped to 700° C. under the same flow of nitrogen and held at this temperature for 60 min. under the same flow of nitrogen. After soaking the sample for 60 min. under the same flow of nitrogen, the furnace was turned off to allow the sample to cool for 2 hours under the same flow of nitrogen. The final weight of the sample was 0.1504 g. FIG. 3 is an SEM of the sample (250× magnification). The sample was essentially intact and showed no inter-fiber bonding.

### EXAMPLE 16

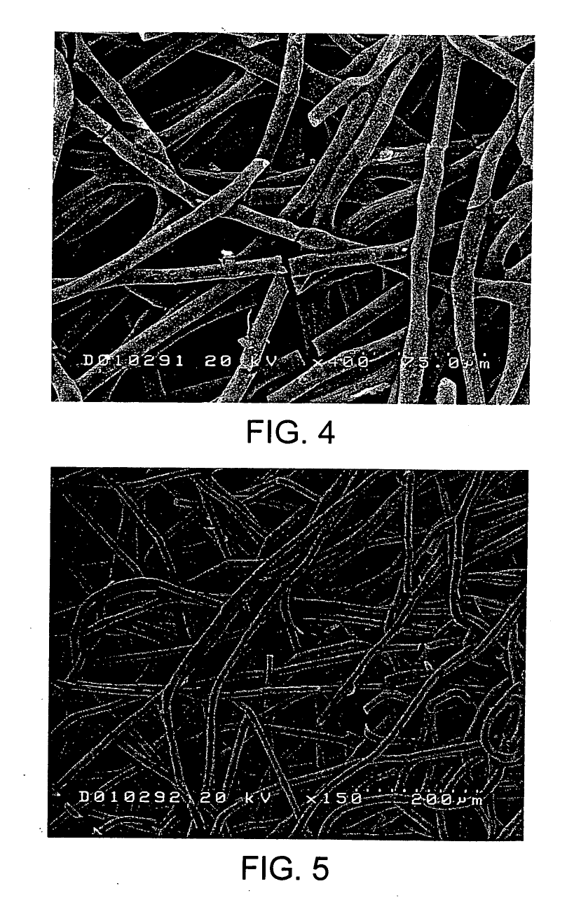

A Courtaulds nonwoven PAN fiber substrate (80 g/m²) weighing 0.1461 g was placed between two quartz plates (without metal shims) and placed into a 4 inch tube furnace. The furnace was ramped to 350° C. at 10° C./min. using a 2 L/min. nitrogen flow. Once the furnace reached 350° C. it was held at this temperature for 90 min. under the same flow of nitrogen. At the end of the 90 min period the furnace was then ramped to 700° C. under the same flow of nitrogen and held at this temperature for 60 min. under the same flow of nitrogen. After soaking for 60 min., the furnace was shut off to allow the sample to cool for 2 hours under the same flow of nitrogen. The final weight of the sample was 0.0670 g. FIG. 4 is an SEM of the sample (400× magnification). The sample was cracked into numerous pieces and showed evidence of bonding. The bonding that is shown in the SEM appeared to be concentrated on the edges of the sample more that in the middle of the sample.

### EXAMPLE 17

A Courtaulds nonwoven PAN fiber substrate (80 g/m²) weighing 0.3872 g was placed between two quartz plates using two metal shims (0.25 mm thick) perpendicular to the sample and set into a 4 inch tube furnace. The furnace was then purged for 15 min with nitrogen using a flow rate of 4L/min. The furnace was ramped to 350° C. at 10° C./min., again using 2L/min nitrogen flow. The furnace was held at 350° C. for 30 min. under the same flow of nitrogen, and then ramped to 700° C. and held there for 60 min. under the same flow of nitrogen. The sample was allowed to cool for 2 hours under the same flow of nitrogen. The final sample weight was 0.2097 g. FIG. 5 is an SEM of the sample (150× magnification). The sample was severely cracked into numerous, small pieces. SEM showed moderate inter-fiber bonding.

### EXAMPLE 18

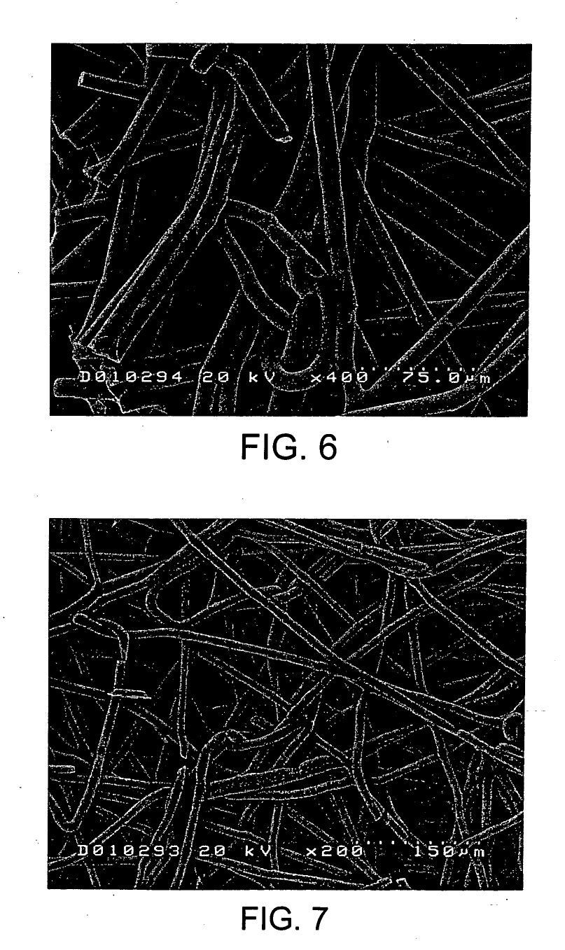

A Courtaulds nonwoven PAN fiber substrate (80 g/m²) weighing 0.2573 g was placed between 2 quartz plates using 2 metal shims perpendicular to the fiber, and set into a 4 inch tube furnace. The furnace was purged for 15 min under 4 L/min. flow of nitrogen. The furnace was then ramped at 10° C./min. under 2 L/min. flow of nitrogen to 700° C. with no stabilization time and held at this temperature under the same flow of nitrogen for 60 min. The sample was allowed to cool for 2 hours under the same flow of nitrogen. The final sample weight was 0.1305 g. FIGS. 6 and 7 are SEM of the sample (400× magnification and 200× magnification, respectively). The sample was cracked into many small pieces. SEM revealed moderate inter-fiber bonding.

### EXAMPLE 19

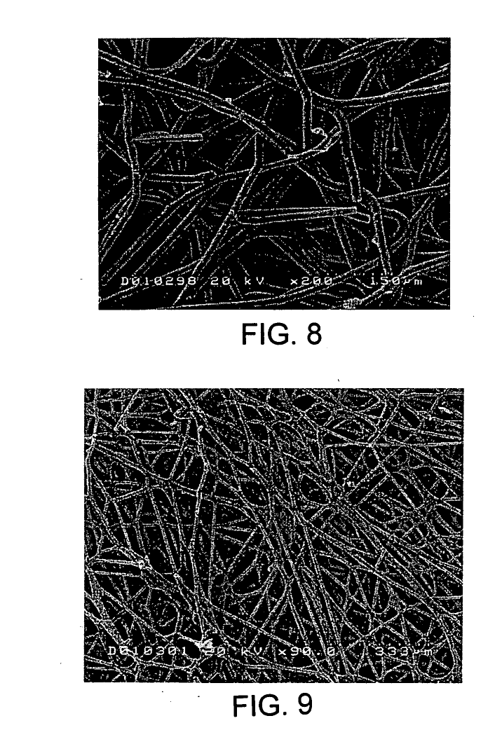

A Courtaulds nonwoven PAN fiber substrate (80 g/m²) weighting 0.2601 g was placed between 2 quartz plates and with 2 metal shims parallel to the fiber, and set into a 4 inch tube furnace. The metal shims were 0.256-0.259 mm thick, slightly thicker than the PAN material. The shims kept the quartz plates from touching the PAN so it could shrink unconstrained. The furnace was purged for 15 min at 4 L/min. flow of nitrogen. The furnace was then ramped at 10° C./min. at 2 L/min. flow of nitrogen to 700° C. with no stabilization time and held at 700C under the same flow of nitrogen for 60 min. The sample was then allowed to cool for 2 hours under the same flow of nitrogen. FIG. 8 is an SEM of the sample (200× magnification). The sample was primarily intact and showed very little inter-fiber bonding. The final sample weight was 0.1335 g.

### EXAMPLE 20

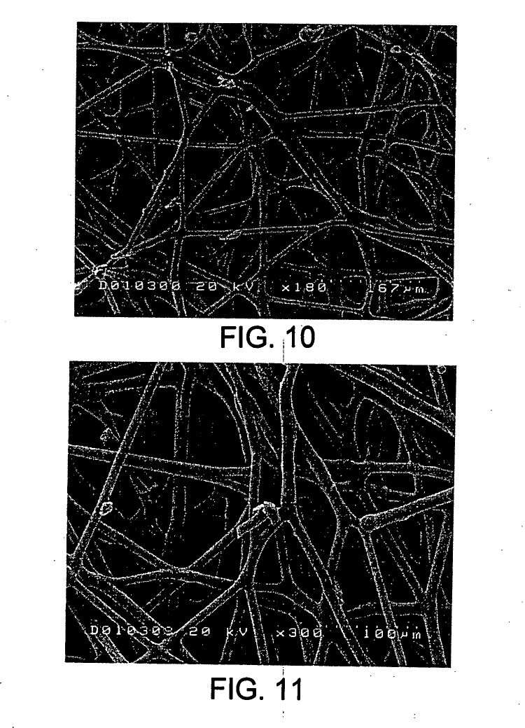

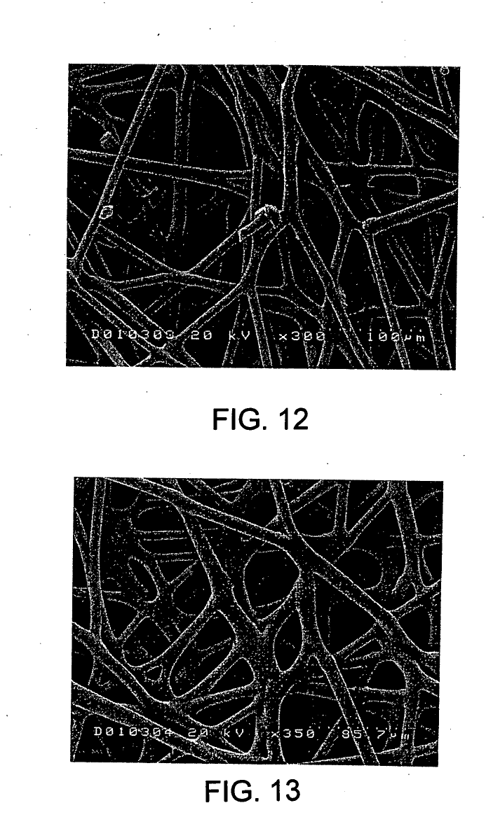

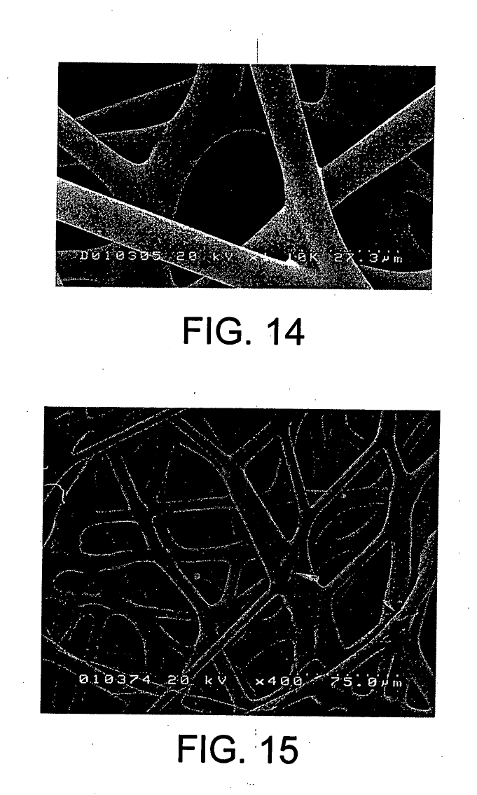

A Courtaulds nonwoven PAN fiber substrate (80 g/m²) weighing 0.252 g was placed between 2 quartz plates using 2 metal shims parallel to the PAN sample as in example 19, and set into a 4 inch tube furnace. The furnace was then purged for 15 min under 4 L/min. flow of nitrogen. The furnace was then ramped at 25° C./min. under 2 L/min. flow of nitrogen to 700° C. with no stabilization time and held for there under the same flow of nitrogen for 60 min. The sample was then allowed to cool for 2 hours under the same flow of nitrogen. FIGS. 9-14 are SEM of the sample (90× magnification, 180× magnification, 300× magnification, 300× magnification, 350× magnification and 1,100× magnification, respectively). The sample broke into three large pieces, and SEM showed considerable inter-fiber bonding. The final sample weight was 0.1235 g.

### EXAMPLE 21

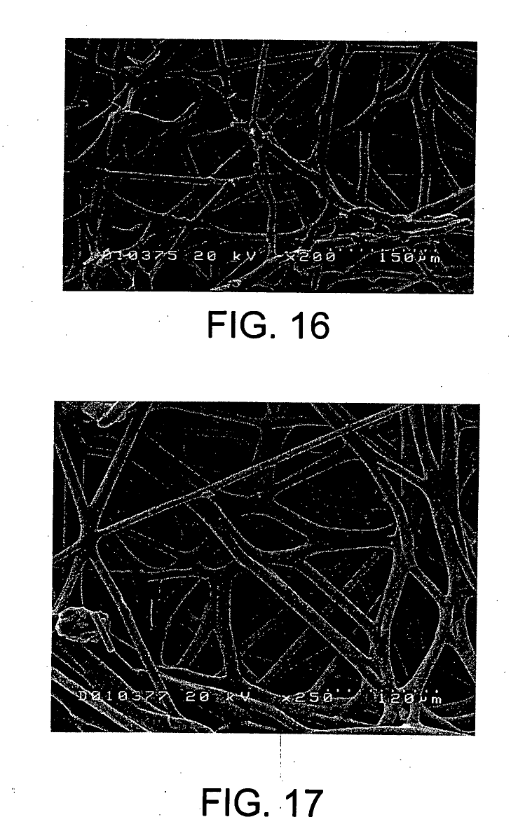

A Courtaulds nonwoven PAN fiber substrate (80 g/m²) weighing 0.1960 g was placed between 2 quartz plates and with 2 metal shims parallel to the fiber, and set into a 4 inch tube furnace. The furnace was then purged for 15 min under 4 L/min. flow of nitrogen. The furnace was then ramped at 25° C./min. under 2 L/min. flow of nitrogen to 900° C. with no stabilization time and held under the same flow of nitrogen for 20 min. The sample was then cooled for 15 min to 700° C. under the same flow of nitrogen and held under the same flow of nitrogen at 700° C. for 25 min. The sample was then allowed to cool for 2 hours under the same flow of nitrogen. FIGS. 15 and 16 are SEM of the sample (400× magnification and 200× magnification, respectively). The sample was in intact, and SEM showed a considerable inter-fiber bonding. The final sample weight was 0.0896 g.

### EXAMPLE 22

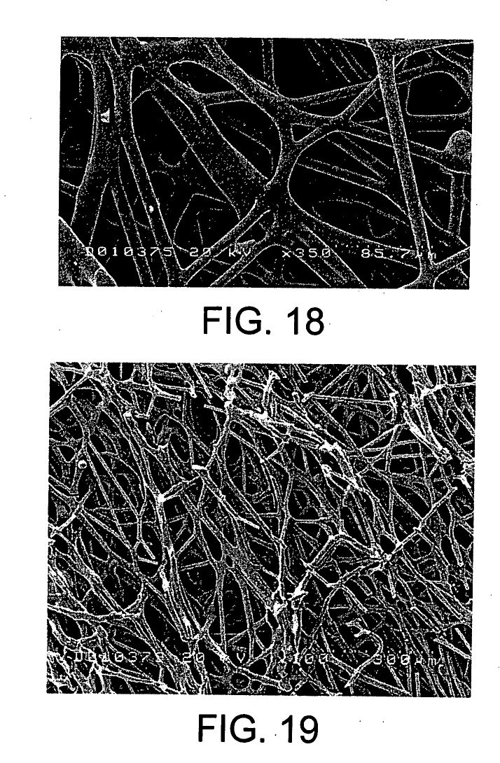

A Courtaulds nonwoven PAN fiber substrate (80 g/m²) weighing 0.2126 g was placed between 2 quartz plates and with 2 metal shims parallel to the fiber, and set into a 4 inch tube furnace. The furnace was then purged for 15 min under 4 L/min. flow of nitrogen. The furnace was then ramped at 25° C./min. under 1 L/min. flow of nitrogen to 700° C. with no stabilization time and held under the same flow of nitrogen for 60 min. The sample was then allowed to cool for 2 hours under the same flow of nitrogen. FIGS. 17 and 18 are SEM of the sample (250× magnification and 350× magnification, respectively). The sample cracked in two large pieces, and SEM showed a considerable amount of inter-fiber bonding. The final sample weight was 0.1063 g.

### EXAMPLE 23

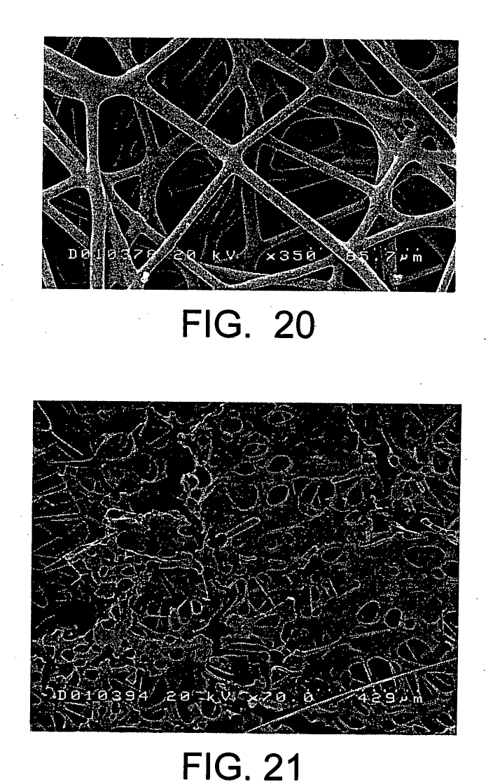

A Courtaulds nonwoven PAN fiber substrate (80 g/m²) weighing 0.2602 g was placed between 2 quartz plates and with 2 metal shims parallel to the fiber, and set into a 4 inch tube furnace. The furnace was then purged for 15 min under 4 L/min. flow of nitrogen. The furnace was then ramped at 25° C./min. under 1 L/min. flow of nitrogen to 900° C. with no stabilization time and held for 60 min under the same flow of nitrogen. The sample was then allowed to cool for 2 hours under the same flow of nitrogen. FIGS. 19 and 20 are SEM of the sample (100× magnification and 350× magnification, respectively). The sample broke into many small pieces, and SEM showed considerable inter-fiber bonding. The final sample weight was 0.1604 g.

### EXAMPLE 24

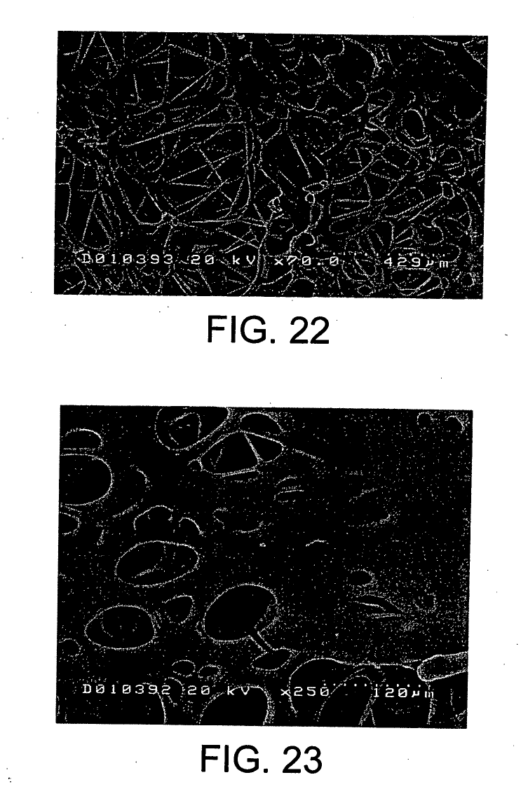

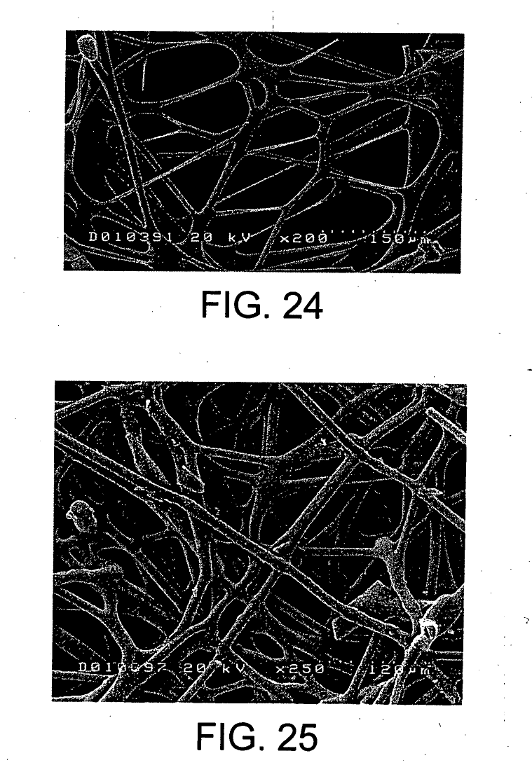

A Courtaulds nonwoven PAN fiber substrate (80 g/m²) weighing 0.1523 g was placed between 2 quartz plates and with 2 metal shims parallel to the fiber, and set into a 4 inch tube furnace. The furnace was then purged for 15 min under 4 L/min. flow of nitrogen. The furnace was then ramped at 50° C./min. under 1 L/min. flow of nitrogen to 900° C. with no stabilization time and held for 60 min under the same flow of nitrogen. The sample was then allowed to cool for 2 hours under the same flow of nitrogen. FIGS. 21-24 are SEM of the sample (70× magnification, 70× magnification, 250× magnification and 200× magnification, respectively). The sample was cracked severely into many small places, and SEM showed considerable inter-fiber bonding. This sample also showed the collapse of the open, porous fiber structure in that the PAN material fused into a solid mass at some locations in the structure. The final sample weight was 0.0923 g.

### EXAMPLE 25

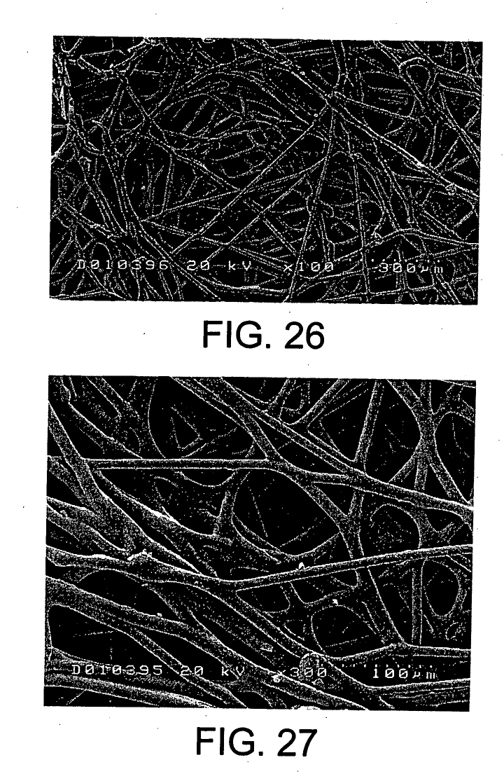

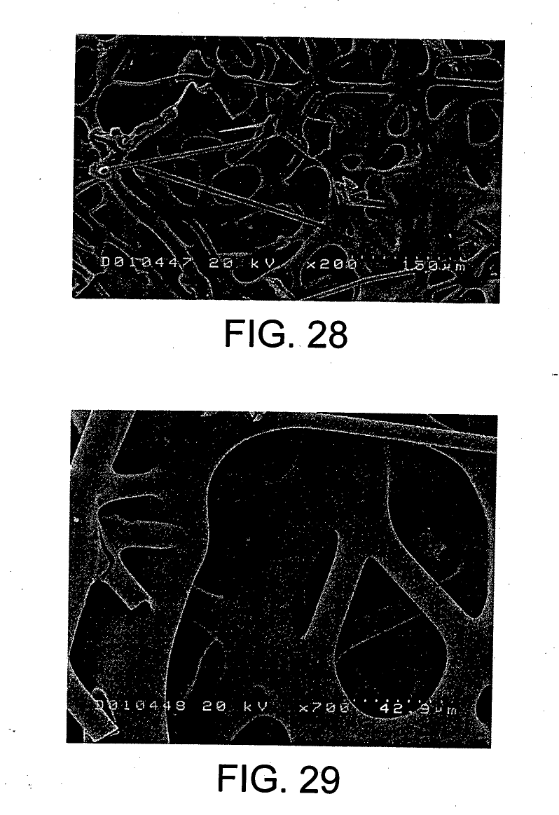

A Courtaulds nonwoven PAN fiber substrate (80 g/m²) weighting 0.1300 g was placed between 2 quartz plates and with 2 metal shims parallel to the fiber, and set into a 4 inch tube furnace. The furnace was then purged for 15 min under 4 L/min. flow of nitrogen. The furnace was then ramped at 23° C./min. under 1 L/min. flow of nitrogen to 900° C. with no stabilization time and held for 60 min under the same flow of nitrogen. The sample was then allowed to cool for 2 hours under the same flow of nitrogen. FIGS. 25-29 are SEM of the sample (250× magnification, 100× magnification, 300× magnification, 200× magnification and 700× magnification, respectively). The sample had one major crack, and SEM showed a considerable amount of inter-fiber bonding. The final sample weight was 0.0623 g.

### EXAMPLE 26

A Courtaulds nonwoven PAN fiber substrate (80 g/m²) weighing 0.2165 g was placed between 2 quartz plates and with 2 metal shims parallel to the fiber, and set into a 4 inch tube furnace. The furnace was then purged for 15 min under 4 L/min. flow of nitrogen. The furnace was then ramped at 40° C./min. under 2 L/min. flow of nitrogen to 700° C. with no stabilization time and held for 60 min under the same flow of nitrogen. The sample was then allowed to cool for 2 hours under the same flow of nitrogen. The sample was cracked into many small pieces, and SEM showed a considerable amount of inter-fiber bonding. This sample, like that in example 25, also showed a collapse of the open, porous fiber structure where the PAN material fused into a solid mass. The final sample weight was 0.1367 g.

While certain embodiments have been described, the invention is not limited to these embodiments.

As an example, in some embodiments, the web can contain a binder. Examples of binders include carbonizable binders, such as carbonizable phenolic resin binders, PTFE and acrylics. An example of a commercially available carbonizable phenolic resin binder is Arofene 8121-Me-65 phenolic resin (Ashland Chemical).

As another example, in certain embodiments, the fibers can be non-homogeneous. For example, the web of fused fibers can have a coating. The coating can be formed, for example, of a metal or an alloy. Examples of coatings include nickel, copper, lead, zinc, cobalt and their alloys. Generally, in embodiments in which the web of fused fibers has a coating, the locations where the fibers are fused are formed of carbon-carbon bonds.

As a further example, in some embodiments, the diameter of the fibers can vary. Using fibers of varying diameter may provide another approach to manipulating the degree to which the fibers in the web are fused, and therefore the flexural strength of the web of fused fibers. For example, fibers of relatively small diameter may tend to become fused during processing sooner than fibers of relatively large diameter. By controlling the process conditions (e.g., temperature, time), the web can be prepared so that the majority of the relatively small diameters are fused while a comparably small amount of the relatively large diameter fibers remain non-fused.

As another example, in some embodiments, some (e.g., all) of the fibers can be formed of a ceramic-containing material, a metal-containing material and/or an alloy-containing material. Examples of ceramic-containing materials include SiC and Nextel®. Examples of metal-containing materials include nickel. Examples of alloy-containing materials include stainless steel.

As an additional example, the webs described herein can be used in various types of fuel cells, including proton electrolyte membrane (PEM) fuel cells and direct methanol fuel cell (DMFC) fuel cells.

As a further example, the webs described herein can be used in applications other than gas diffusion layers. In some embodiments, the webs can be used as a nickel electrode substrate in a nickel-hydride battery. In certain embodiments, the webs can be used in the electrochemical treatment of waste (e.g., metal reclaiming). In some embodiments, the webs can be used as a filtration material (e.g., to remove charged materials from a mixture). In certain embodiments, the webs can be used as a conductive material in a double layer capacitor.

Other embodiments are in the claims.

1. A fuel cell gas diffusion layer, comprising:
a plurality of substantially homogeneous carbon-containing fibers,
wherein at least some of the fibers are fused, and the fuel cell gas diffusion layer has a flexural strength of at least about 300 psi.

2. The fuel cell gas diffusion layer of claim 1, wherein the fuel cell gas diffusion layer has a flexural strength of at least about 450 psi.

3. The fuel cell gas diffusion layer of claim 1, wherein the fuel cell gas diffusion layer has a flexural strength of at least about 600 psi.

4. The fuel cell gas diffusion layer of claim 1, wherein the fuel cell gas diffusion layer has a strength of at least about four pounds per inch.

5. The fuel cell gas diffusion layer of claim 1, wherein the wherein the fuel cell gas diffusion layer has a strength of at least about six pounds per inch.

6. The fuel cell gas diffusion layer of claim 1, wherein the fuel cell gas diffusion layer has a strength of at least about 10 pounds per inch.

7. The fuel cell gas diffusion layer of claim 1, wherein the fuel cell gas diffusion layer has an in-plane resistivity of at most about 50 mΩ-cm.

8. The fuel cell gas diffusion layer of claim 1, wherein the fuel cell gas diffusion layer has an in-plane resistivity of at most about 10 mΩ-cm.

9. The fuel cell gas diffusion layer of claim 1, wherein the fuel cell gas diffusion layer has an in-plane resistivity of at most about five mΩ-cm.

10. The fuel cell gas diffusion layer of claim 1, wherein the fuel cell gas diffusion layer has a through-plane resistivity of at most about 200 mΩ-cm.

11. The fuel cell gas diffusion layer of claim 1, wherein the fuel cell gas diffusion layer has a through-plane resistivity of at most about 50 mΩ- cm.

12. The fuel cell gas diffusion layer of claim 1, wherein the fuel cell gas diffusion layer has a through-plane resistivity of at most about 10 mΩ- cm.

13. The fuel cell gas diffusion layer of claim 1, wherein the fuel cell gas diffusion layer has a porosity of at least about 30%.

14. The fuel cell gas diffusion layer of claim 1, wherein the fuel cell gas diffusion layer has a porosity of at least about 60%.

15. The fuel cell gas diffusion layer of claim 1, wherein the fuel cell gas diffusion layer has a porosity of at least about 80%.

16. The fuel cell gas diffusion layer of claim 1, wherein the fuel cell gas diffusion layer is in the form of a web.

17. The fuel cell gas diffusion layer of claim 16, wherein the web is substantially binder-free.

18. A method of forming a fuel cell gas diffusion layer, the method comprising:
treating a first web of fibers at a temperature of at most about 250° C. to form a second web of fibers; and
treating the second web of fibers at a temperature of at least about 400° C. to form the fuel cell gas diffusion layer.

19. The method of claim 18, wherein the first web is treated at a temperature of at most about 240° C.

20. The method of claim 18, wherein the first web is treated at a temperature of at most about 230° C.

21. The method of claim 18, wherein the second web is treated at a temperature of at least about 500° C.

22. The method of claim 18, wherein the second web is treated at a temperature of at least about 600° C.

23. The method of claim 18, wherein the second web is treated at a temperature of at most about 1100° C.

24. The method of claim 18, wherein the first web is treated in a substantially inert gas environment.

25. The method of claim 18, wherein the second web is treated in a substantially inert gas environment.

26. The method of claim 18, wherein the first web is treated at a pressure of at least about one atmosphere.

27. The method of claim 18, wherein the second web is treated at a pressure of at least about one atmosphere.

28. The method of claim 18, further comprising flowing a gas at a rate of at least about 0.5 liters per minute while treating the first web.

29. The method of claim 18, further comprising flowing a gas at a rate of at least about 0.5 liters per minute while treating the first web.

30. The method of claim 18, wherein the fuel cell gas diffusion layer comprises a web of fibers.

31. The method of claim 30, wherein the fibers are substantially homogeneous carbon-containing fibers.

32. The method of claim 30, wherein at least some of the fibers are fused.

33. The method of claim 30, wherein the web is substantially binder-free.

34. A method of forming a fuel cell gas diffusion layer, the method comprising:
treating a first web of fibers at a temperature of at most about 250° C. to form a second web of fibers; and
treating the second web of fibers at a temperature of at most about 1100° C. to form the fuel cell gas diffusion layer.

35. The method of claim 34, wherein the second web is treated at a temperature of at most about 1050° C.

36. The method of claim 34, wherein the second web is treated at a temperature of at most about 1000° C.

37. The method of claim 34, wherein the first web is treated in a substantially inert gas environment.

38. The method of claim 34, wherein the second web is treated in a substantially inert gas environment.

39. The method of claim 34, wherein the first web is treated at a pressure of at least about one atmosphere.

40. The method of claim 34, wherein the second web is treated at a pressure of at least about one atmosphere.

41. The method of claim 34, further comprising flowing a gas at a rate of at least about 50 sccm while treating the first web.

42. The method of claim 34, further comprising flowing a gas at a rate of at least about 50 sccm while treating the first web.

43. The method of claim 34, wherein the fuel cell gas diffusion layer comprises a web of fibers.

44. The method of claim 43, wherein the fibers are substantially homogeneous carbon-containing fibers.

45. The method of claim 43, wherein at least some of the fibers are fused.

46. The method of claim 43, wherein the web is substantially binder-free.

47. A membrane electrode assembly, comprising:
a first catalyst layer;
a second catalyst layer;
a solid electrolyte;
a first gas diffusion layer, the first gas diffusion layer comprising a plurality of substantially homogeneous carbon-containing fibers, at least some of the fibers being fused; and
a second gas diffusion layer,
wherein the first catalyst layer is between the solid electrolyte and the first gas diffusion layer, the second catalyst layer is between the solid electrolyte the second gas diffusion layer, and the first gas diffusion layer has a flexural strength of at least about 300 psi.

48. The membrane electrode assembly of claim 47, wherein the second gas diffusion layer comprises a plurality of substantially homogeneous carbon-containing fibers, at least some of the fibers in the second gas diffusion layer are fused, and the second gas diffusion layer has a flexural strength of at least about 300 psi.

49. A fuel cell, comprising:
a first flow plate;
a second flow plate; and
the membrane electrode assembly according to claim 47, the membrane electrode assembly being between the first and second flow plates.
